(19) United States
(12) Patent Application Publication
(10) Pub. No.: US 2010/0219752 A1
(43) Pub. Date: Sep. 2, 2010

(54) QUARTZ BULB FOR DOUBLE ENDED DISCHARGE LAMP

(75) Inventors: Makoto Ohkahara, Saitama (JP); Shoji Yamamoto, Saitama (JP)

Correspondence Address: GREENBLUM & BERNSTEIN, P.L.C., 1950 ROLAND CLARKE PLACE, RESTON, VA, 20191, US

(73) Assignee: IWASAKI ELECTRIC CO., LTD., Tokyo (JP)

(21) Appl. No.: 12/675,409

(22) PCT Filed: May 26, 2008
(86) PCT No.: PCT/JP2008/059656

§ 371 Date: Feb. 26, 2010

(30) Foreign Application Priority Data
Aug. 29, 2007 (JP) 2007-221978

(51) Int. Cl. H01J 61/36

(52) U.S. Cl. 313/623

(57) ABSTRACT

In a case of manufacturing a double ended discharge lamp, it is intended to decrease the manufacturing cost while maintaining identical lamp characteristic and lamp lifetime with those in a case of forming a quartz bulb with quartz at a high purity.

In a quartz bulb (1) in which a pair of straight tube portions (2A, 2B) each having a sealing tube (4A, 4B) for sealing an electrode mount (M) and a supply/exhaust tube (5A, 5B) that is cut and removed after sealing in communication to each other are formed on both ends of a chamber (3) as a light emitting portion, end portions (1A, 1B) of the quartz tube including the entire portion or a portion of the supply/exhaust tubes (5A, 5B) are formed in contiguous with the central portion (10) of the quartz tube including all portions forming the inner surface (3a) of the chamber, and one or both of the end portions (1A, 1B) of the quartz tube is formed of quartz at a purity lower than that of the central portion (10) of the quartz tube.

### TECHNICAL FIELD

The present invention concerns a quartz bulb for a double ended discharge lamp in which a straight tube portions each having a sealing tube and a supply/exhaust tube in communication to each other are formed on both ends of a quartz tube having a chamber as a light emitting portion formed in a middle part.

### BACKGROUND ART

In a current double ended high pressure discharge lamps used generally such as a headlight for an automobile or a backlight for a projector, since bursting tends to occur possibly during operation at high temperature and high pressure in a case where the distribution of the thickness of the discharge tube is not uniform, a quartz bulb of uniform thickness distribution where the exhaust tube residue (tip) is not preset in the light emitting portion is used and, since tip is not formed to the quartz bulb, it is also referred to as a tipless lamp.

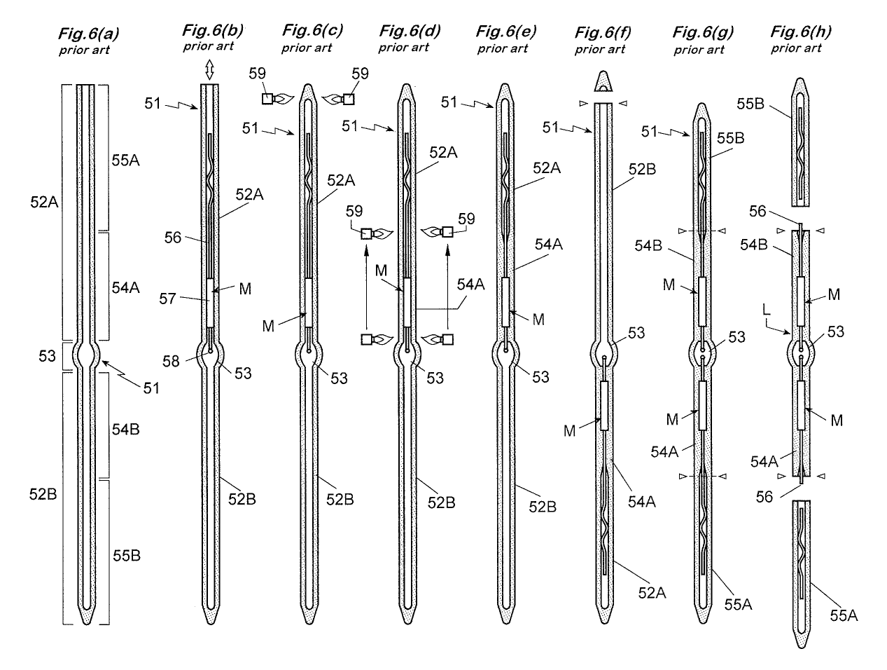

For example, as shown in FIG. 6(a), in a quartz bulb 51 of a double ended discharge lamp, a chamber 53 as a light emitting portion is formed between a pair of straight tube portions 52A and 52B formed on both longitudinal ends of one quartz tube.

In the straight tube portions 52A, 52B, portions on the side of the chamber 53 are formed as sealing tubes 54A, 54B for airtightly sealing the chamber 53 in a state of inserting electrode mounts M, and portions on the side of the open ends are formed as supply/exhaust tubes 55A, 55B which are cut and removed after sealing the sealing tubes 54A, 54B, and the portions function as supply/exhaust flow channels for an excess gas and a sealing gas relative to the chamber 53 before sealing.

Then, when the lamp is manufactured, the top end of one straight tube portion 52B of the quartz bulb 51 is previously closed and, as shown in FIG. 6(b), the electrode mount M that is welded with a tungsten electrode 58 by way of a molybdenum foil 57 is inserted on the side of the top end of a lead wire 56 in a state of directing the open end of the other straight tube portion 52A upward, then the supply/exhaust tube 55A is connected to a vacuum pump (not illustrated) to exhaust air in the inside of the quartz bulb 51 and an inert gas such as an argon gas is filled.

Then, as shown in FIG. 6(c), after provisionally sealing an upper end opening of the supply/exhaust tube 55A by a burner 59, when the sealing tube 54A is heated while vertically moving the burner 59 upwardly as shown in FIG. 6(d), the one electrode mount M is airtightly sealed as shown in FIG. 6(e).

Then, it is turned upside to down, the top end of the straight tube portion 52B is opened as shown in FIG. 6(f) and, when the other electrode mount 52 is inserted from above and the same steps as those in FIGS. 6(b) to (d) are repeated, each of the sealing tubes 54A, 54B on both ends of the quartz bulb 51 is airtightly sealed in a state of opposing the pair of electrodes 58 to each other in the chamber 53 as shown in FIG. 6(g).

Finally, as shown in FIG. 6(h), when the sealing tubes 54A, 54B in communication with the supply/exhaust tubes 55A, 55B are cut and removed respectively with the lead wires 57 being exposed from them, a high pressure discharge lamp L is completed.

[Patent Document 1] JP-No. 3653195

As described above, the quartz bulb 51 requires not only the sealing tubes 54A and 54B formed on both side of the chamber 53 but also the supply/exhaust tubes 55A, 55B in communication with the sealing tubes 54A and 54B for supporting the electrode mounts M in the quartz bulb, and evacuating the inside of the chamber and supplying the inert gas thereto, and the length thereof is extremely longer than that of the discharge lamp which is formed finally as a product.

On the other hand, a high pressure discharge lamp used in recent years as a backlight for a projector is sealed with mercury, for example, at 16.5 mg relative to 80 mm³ of an inner volume (about 0.205 mg/mm³) and lit at a lamp power of 125 W, and a lamp which is extremely smaller compared with existent mercury lamps for general illumination use is sealed with mercury at a high density and lit at a high tube wall load.

[Patent Document 2] JP No. 3216877

While a high efficiency is obtained by lighting at such a high tube wall load, since it is operated at a high temperature and a high pressure, an impurity gas or an impurity contained in an electrode material and a quartz material gives a significant effect on the lamp lifetime.

Accordingly, for attaining a higher efficiency of the lamp and obtaining a longer lifetime, not only an electrode material at a high purity has been used but also quartz at a high purity has been used for a quartz bulb. However, the cost of quartz at such a high purity is outstandingly higher compared with that of existent quartz.

Particularly, in a case of manufacture the tipless lamp as described above, the quartz bulb has to be formed sufficiently longer than an actual lamp since the both ends thereof are cut off and a quartz tube of a high purity which is extremely expensive has to be used also to a portion which is finally cut out and discarded, so that this results in a problem of increasing the material cost.

### DISCLOSURE OF THE INVENTION

### Subject to be Solved by the Invention

In view of the above, it is a technical subject of the present invention to provide identical lamp characteristic and lamp lifetime compared with the case of forming a quartz bulb with quartz at high purity and enable to decrease the material cost.

### Means for Solving the Subject

For solving the subject, the present invention provides a quartz bulb for a double ended discharge lamp in which a chamber as a light emitting portion is formed between a pair of straight tube portions formed on both longitudinal ends of the quartz tube, the straight tube portion is formed as a sealing tube for airtightly sealing the chamber in a state of inserting an electrode mount at a part on the side of the chamber, and formed as a supply/exhaust tube which is cut and removed after sealing the sealing tube at a part on the side of the top end, wherein

a central portion of the quartz tube including at least all portions forming the inner surface of the chamber when the sealing tube is airtightly sealed and an end portion of the quartz tube including the entire portion or a portion of the supply/exhaust tube are formed continuously, and one or both of the end portions with the quartz tube is formed of quartz at a purity lower than that of the central portion of the quartz tube.

### Effect of the Invention

According to the present invention, two types of quartz at different purifies are used, in which the central portion of the quartz tube including all portion forming the inner surface of the chamber is formed of quartz at a high purity, and the end portions of the quartz tubes in contiguous with both ends thereof are formed of quartz at a low purity.

Since the end portion of the quartz tube includes the entire portion or at least a portion of the supply/exhaust tube to be cut and removed and the portion thereof is formed of quartz at a low purity with a less expensive material cost, the manufacturing cost is decreased by so much.

In this case, since the central portion of the quartz tube constituting the inner surface of the chamber is formed of quartz at the high purity, impurities contained in the quartz are not deposited in the inside of a light emitting space, or clouding (devitrification) to the quartz tube does not occur at the inner surface of the light emitting portion in an early stage due to high temperature during lighting, and not only the lamp characteristic quite identical with that in a case of forming the light emitting tube by using only quartz at the high purity can be provided but also long lifetime can be satisfied also for the lamp lifetime in the same manner.

### Best Mode for Practicing the Invention

In this embodiment, in order to attain the purpose capable of decreasing the manufacturing cost compared with those in a case of forming the quartz bulb with a quartz at high purity while maintaining identical lamp characteristic and lamp lifetime,

this embodiment provides a quartz bulb for a double ended discharge lamp, in which a chamber as a light emitting portion is formed between a pair of straight tube portions formed on both longitudinal ends of the quartz tube, the straight tube portion is formed at a part on the side of the chamber as a sealing tube for airtightly sealing the chamber in a state of inserting an electrode mount and formed at a part on the side of the top end as a supply/exhaust tube which is cut and removed after sealing the sealing tube, wherein

a central portion of the quartz tube including at least all portions forming the inner surface of the chamber when the sealing tube is airtightly sealed and an end portion of the quartz tube including the entire portion or a portion of the supply/exhaust tube are formed continuously, and one or both of the end portions of the quartz tube is formed of quartz at a purity lower than that of the central portion of the quartz tube.

The present invention is to be described with reference to examples shown in the drawings.

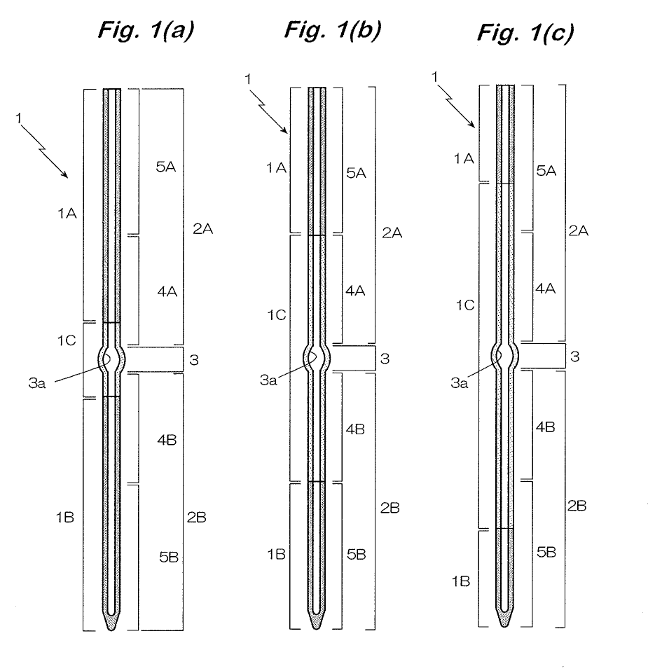

FIG. 1 is an explanatory view showing an example of a quartz bulb for a double ended discharge lamp according to the present invention.

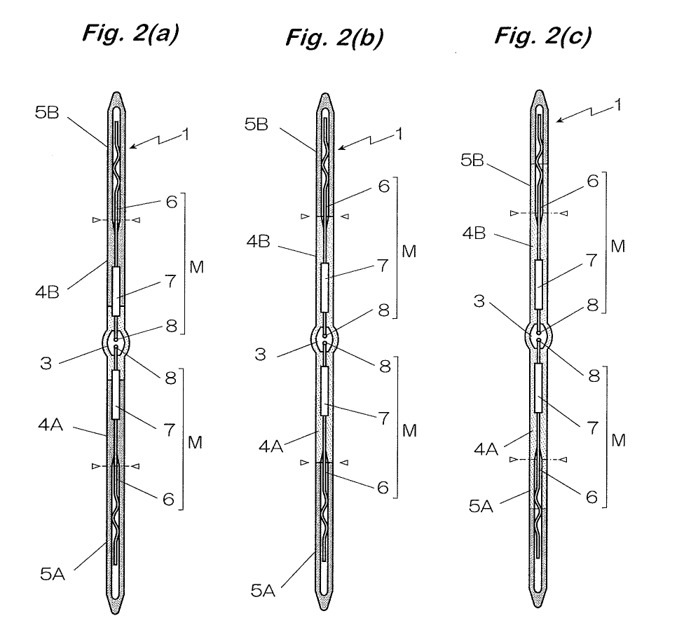

FIG. 2 is an explanatory view showing the state of sealing an electrode mount.

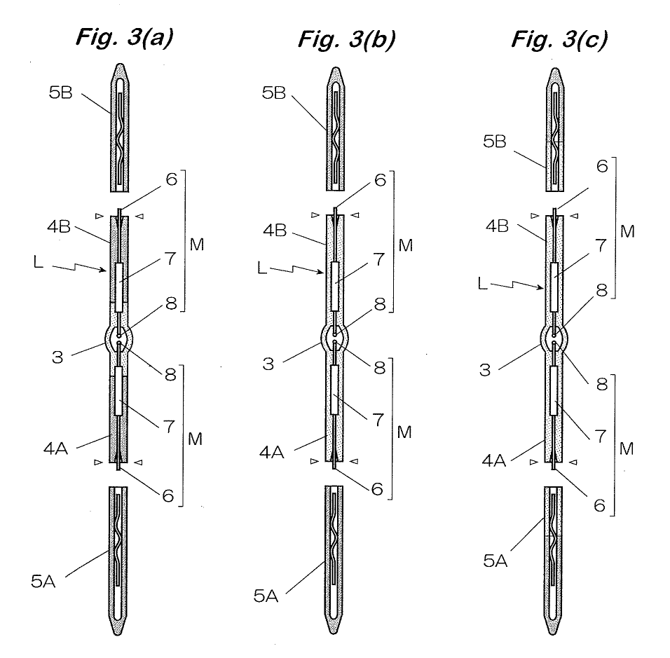

FIG. 3 is an explanatory view showing the state of cutting a supply/exhaust tube.

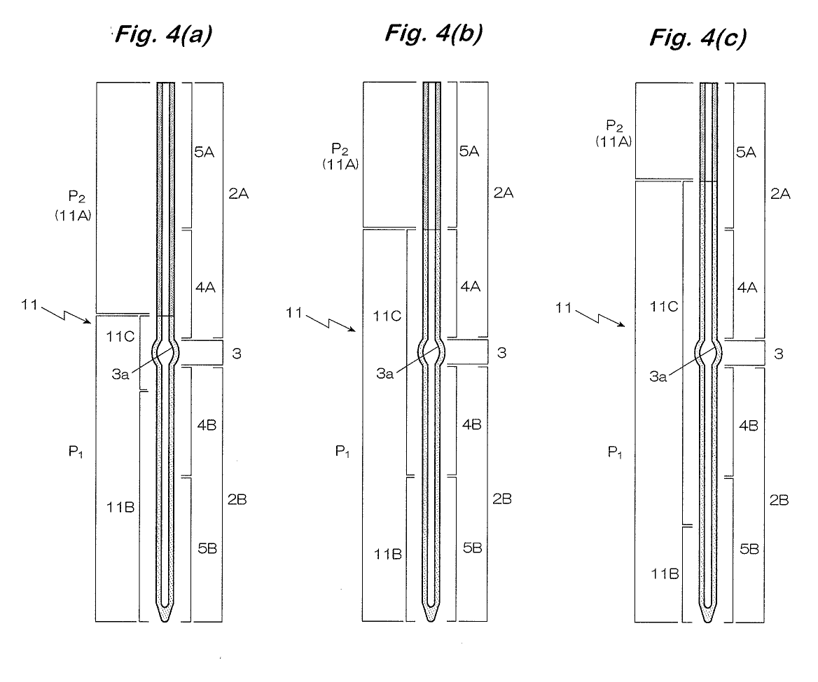

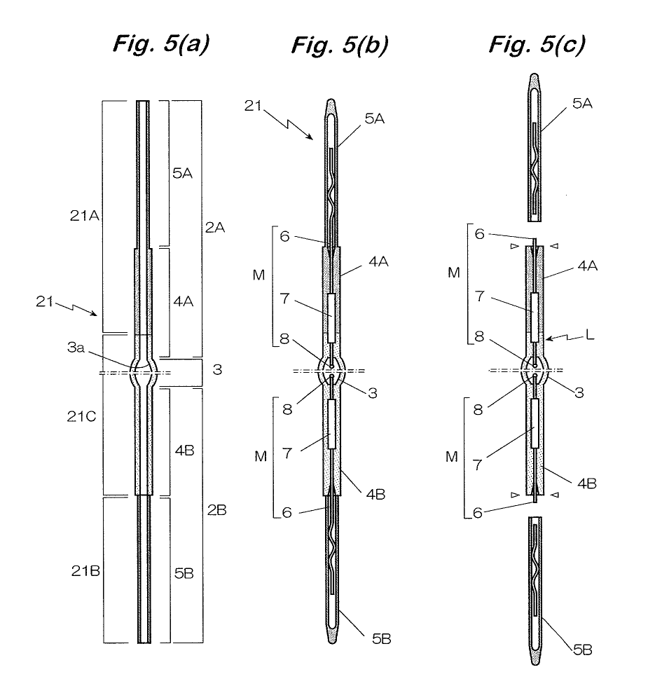

FIGS. 4 to 5 are explanatory views showing other embodiments.

### EXAMPLE 1

In a quartz bulb 1 for a double ended discharge lamp shown in FIG. 1, a chamber 3 as a light emitting portion is formed between a pair of straight tube portions 2A and 2B formed on both longitudinal ends of the quartz tube.

In the straight tube portions 2A, 2B, portions on the side of the chamber 3 are formed as sealing tubes 4A, 4B for airtightly sealing the chamber in a state of inserting electrode mounts M, and the portions on the side of the top ends are formed as supply/exhaust tubes 5A, 5B which are cut and removed after sealing the sealing tubes 4A, 4B.

The supply/exhaust tubes 5A, 5B are connected to an exhaust system (not illustrated) such as a vacuum pump and a sealing gas supply system (not illustrate) during manufacture of the lamp, and they function as an exhaust gas flow channel of an excess gas and a supply gas flow channel of a sealing gas relative to the chamber 3 before sealing.

Further, the quartz bulb 1 is of 3-piece structure having a central portion 10 of a quartz tube including at least all portions forming the inner surface 3a of the chamber when the sealing tubes 4A, 4B are airtightly sealed, and end portions 1A and 1B of the quartz tube on the top end side of the straight tube portions formed continuously on both sides thereof. Both end portions 1A and 1B of the quartz tube are formed of quartz at a purity lower than that of the central portions 10 of the quartz tube.

The length of the central portion 10 of the quartz tube can be optionally selected as required such that it is shorter than the total length for the chamber 3 and the sealing tubes 4A, 4B as shown in FIG. 1(a), equal with that as shown in FIG. 1(b), or longer than that as shown in FIG. 1(c).

In a case where the length for the central portion 10 of the quartz tube is less than the total length for the chamber 3 and the sealing tubes 4A, 4B, the entire portion of the supply/exhaust tubes 5A, 5B are included in the end portions 1A and 1B of the quartz tube and, when it is longer than the total length for the chamber 3 and the sealing tubes 4A, 4B, portions of the supply/exhaust tubes 5A, 5B constitute the end portions 1A, 1B of the quartz tube.

For example, in a case where it is designed such that the total length for the quartz bulb 1 is 280 mm, the total lamp length for the chamber 3 and the sealing tubes 4A, 4B is 80 mm, and the length for the supply/exhaust tubes 5A and 5B which are cut and removed after sealing is 100 mm, the length for the central portion 10 of the quartz tube is about 20 mm, the length for the end portions 1A and 1B of the quartz tube is 100 mm in the quartz bulb 1 shown in FIG. 1(a), the length for the central portion 10 of the quartz tube is about 80 mm, and length for the end portions 1A and 1B of the quartz tube is 100 mm in the quartz bulb 1 shown in FIG. 1(b), and the length for the central portion 10 of the quartz tube is about 160 mm, and the length for the end portions 1A and 1B of the quartz tube is 60 mm in the quartz bulb 1 shown in FIG. 1(c).

When the quartz bulb 1 is manufactured, a quartz tube at a high purity having 2 mm inner diameter, 6 mm outer diameter and a predetermined length (for example, PH 370, manufactured by Philips Co.) is used for a portion as the central portion 10 of the quartz tube, and a quartz tube used for usual lamp at a low quartz purity of a predetermined length and having equal inner and outer diameters (for example, PH 300, manufactured by Philips Co.) is used for portions as the end portions 1A and 1B of the quartz tube on both ends thereof, and they are fused to form a single quartz tube.

Then, the quartz tube is set in a mold for molding, an inner pressure is applied while heating a portion to be formed as the chamber 3, and the portion is expanded into a substantially spheroidal shape having an outer diameter of 10 mm and an inner diameter of 4 mm to thereby form a chamber 3 as a light emitting portion.

Thus, the supply/exhaust tubes 5A, 5B which are cut and removed are entirely or partially formed of the quartz at a low purity in accordance with the length of the central portion 1C of the quartz tube.

A constitutional example of the invention is as has been described above and the offset thereof is to be described with reference to the manufacturing steps of a double ended discharge lamp. For steps identical with those in FIG. 6, detailed explanations therefor are to be omitted.

At first, as shown in FIGS. 1(a) to (c), the lower end of the straight tube 2B of the quartz bulb 1 is previously closed, for example, by heat processing, an electrode mount M having a tungsten electrode 8 welded by way of a molybdenum foil 7 to the top end of a lead wire 6 is inserted from an open end of the other straight part 2A which is directed upwardly, a sealing tube 5A is sealed by the same procedures as those in FIGS. 6(b) to (d), then the quartz bulb 1 is turned upside to down, and an electrode mount M is sealed in the straight tube portion 5B on the opposite side by the same procedures as those in FIGS. 6(b) to (d) (Refer to FIGS. 2(a) to (c)).

After completing the sealing for a pair of electrode mounts M as described above, when the top ends of lead wires 7 are exposed from respective sealing tubes 4A and 4B, and the supply/exhaust tubes 5A, 5B in contiguous therewith are cut and removed as shown in FIGS. 3(a) to (c), a double ended discharge lamp L is completed. Since the supply/exhaust tubes 5A and 5B that are cut off are entirely or partially formed of quartz at a low purity, the manufacturing cost is decreased compared with a case of forming all portions with quartz at a high purity.

### EXAMPLE 2

FIG. 4 shows a further example. Portions identical with those in FIG. 1 carry the same references, for which detailed explanations are to be omitted.

A quartz bulb 11 for a double ended discharge lamp in this example is different from Example 1 in that it is of a 2-piece structure having a main piece P₁ including a central portion 11C of a quartz tube and an end portion 11B of a quartz tube on one side, and a sub-piece P₂ including an end portion 11A of quartz tube on the other hand.

Then, the main piece P₁ is formed of quartz at a high purity and the sub piece P₂ is formed of quartz at a low purity.

The length for the main piece P₁ can be optionally selected as required such that it is made shorter than the total length for the chamber 3 and the sealing tube 4B on one side as shown in FIG. 4(a), made equal therewith as shown in FIG. 4(b), or made longer than that as shown in FIG. 4(c).

In a case of manufacturing a discharge lamp by using the quartz bulb 11, for the supply/exhaust tubes 5A and 5B which are to be cut and removed, since the supply/exhaust tube 5A on one side can be entirely or partially formed of quartz at the low purity, the material cost can be decreased and, hence, the manufacturing cost can be decreased compared to a case of forming the portion entirely of quartz at the high purity.

### EXAMPLE 3

FIG. 5 shows a still further example. In a quartz bulb 21 for a doubled ended discharge lamp of this example, the thickness of the supply/exhaust tubes 5A, 5B which are cut and removed after sealing the sealing tubes 4A and 4B is made thin thereby also decreasing the amount of quartz at a low purity to be discarded and intending to decrease the material cost.

In the upper part of FIGS. 5(a) to (c), the length for the central portion 21C of the quartz tube is formed shorter than the total length for the chamber 3 and the sealing tubes 4A, 4B, and the outer diameter of an end portion 21A (21B) of the quartz tube is made larger for the portion of the sealing tube 4A (4B) and made smaller for the portion of a supply/exhaust tube 5A (25B). In the lower part of FIGS. 5(a) to (c), the length for the central portion 21C of the quartz tube is formed equal with the total length for the chamber 3 and the sealing tubes 4A, 4B, and the end portion 21B (21A) of the quartz tube as the supply/exhaust tube 5B (5A) is formed diametrically smaller compared with the portion of the sealing tube 4B (4A) of the central portion 21C of the quartz tube.

In a case of manufacturing a discharge lamp by using the quartz bulb 21, at first, the lower end of the straight tube portion 2B of the quartz bulb 21 is previously closed, for example, by heat processing as shown FIG. 5(a), an electrode mount M having a tungsten electrode 8 welded by way of a molybdenum foil 7 to the top end of a lead wire 6 is inserted from the open end of the other straight tube portion 2A directed upward, the sealing tube 5A is sealed by the same procedures as those in FIGS. 6(b) to (d), then the quartz bulb 1 is turned upside to down, and an electrode mount M is sealed into the sealing tube 5B on the opposite side by the same procedures as those in FIGS. 6(b) to (d).

Then, finally, after completing the sealing for the pair of electrode mounts M as described above, when the top ends of the lead wires 7 are exposed from the respective sealing tubes 4A, 4B and supply/exhaust tubes 5A, 5B connected therewith are cut and removed as shown in FIG. 5(c), a double ended discharge lamp L is completed.

Since the supply/exhaust tubes 5A and 5B to be cut off are not only formed entirely or partially of quartz at the low purity but also formed diametrically smaller compared with the sealing tubes 4A and 4B, the amount of use of quartz can be saved and the amount of quartz to be discarded as industrial wastes can also be decreased, so that the material cost can be decreased by so much and, thus, the manufacturing cost can be decreased.

Further, identical or greater effects can be obtained in the same manner also by decreasing the thickness of the end portions 1A and 1B of the quartz tube in FIG. 1.

Further, in any of the Examples 1 to 3 described above, since the central portion 10 of the quartz tube constituting the inner surface of the chamber is formed of quartz at the high purity, impurities contained in the quartz are not deposited in the light emitting space, or clouding (devitrification) does not occur to the quartz tube at the inner surface of the light emitting portion in an early stage due to high temperature during lighting, so that it is possible not only to provide lamp characteristics quite identical with those in a case of forming the light emitting tube by using only the quartz at the high purity, but also to satisfy a long lifetime also with respect to the lamp lifetime.

### INDUSTRIAL APPLICABILITY

As has been described above, the present invention is applicable to the use of a quartz bulb which is used upon manufacture of a tipless type double ended discharge lamp.

### BRIEF DESCRIPTION OF THE DRAWINGS

[FIG. 1] An explanatory view showing an example of a quartz bulb for a double ended discharge lamp according to the present invention.

[FIG. 2] An explanatory view showing the state of sealing an electrode mount.

[FIG. 3] An explanatory view showing the state of cutting off a supply/exhaust tube.

[FIG. 4] An explanatory view showing other embodiment.

[FIG. 5] An explanatory view showing other embodiment.

[FIG. 6] An explanatory view showing an existent quartz bulb and steps of assembling a discharge lamp using the same.

### DESCRIPTION OF REFERENCES

1, 11, 21 Quartz bulb for double ended discharge lamp
1A, 11A, 21A End portion of quartz tube
1B, 11B, 21B End portion of quartz tube
1C, 11C, 21C Central portion of quartz tube
2A, 2B Straight tube portion
3 Chamber
3a Inner surface of chamber
M Electrode mount
4A, 4B Sealing tube
5A, 5B Supply/exhaust tube
L Double ended discharge lamp

1. A quartz bulb for a double ended discharge lamp in which a chamber as a light emitting portion is formed between a pair of straight tube portions formed on both longitudinal ends of a quartz tube, and the straight tube portion is formed at a part on the side of the chamber as a sealing tube for airtightly sealing the chamber in a state of inserting an electrode mount, and formed at a part on the side of the top end as a supply/exhaust tube which is cut and removed after sealing the sealing tube, wherein
a central portion of the quartz tube including at least all portions forming the inner surface of the chamber when the sealing tube is airtightly sealed and an end portion of quartz tube including the entire portion or a portion of the supply/exhaust tube are formed continuously, and one or both of the end portions of the quartz tube is formed of quartz at a purity lower than that of the central portion of the quartz tube.

2. A quartz bulb for a double ended discharge lamp according to claim 1, wherein the quartz tube is formed of 2 pieces having an end portion of the quartz tube on one side and a portion where a central portion of the quartz tube and the end portion of the quartz tube on the other side are formed integrally, and the end portion of the quartz tube on one side is formed of quartz at a purity lower than that of the portion including the central portion of the quartz tube.

3. A quartz bulb for a double ended discharge lamp according to claim 1, wherein the quartz tube is foamed of 3 pieces having a central portion of the quartz tube and end portions of the quartz tube on the top end sides of the straight tube portions formed on both sides thereof, and both of the end portions of the quart tube are formed of quartz at a purity lower than that of the central portion of the quartz tube.
